(19) United States
(12) Patent Application Publication
(10) Pub. No.: US 2016/0123184 A1
(43) Pub. Date: May 5, 2016

(54) COMBINED FAN CASE ICE LINER AND REAR LINER

(71) Applicant: United Technologies Corporation, Hartford, CT (US)

(72) Inventor: Steven Clarkson, Cheshire, CT (US)

(73) Assignee: UNITED TECHNOLOGIES CORPORATION, Hartford, CT (US)

(21) Appl. No.: 14/944,491

(22) Filed: Nov. 18, 2015

Related U.S. Application Data
(63) Continuation of application No. PCT/US2014/055593, filed on Sep. 15, 2014.
(60) Provisional application No. 61/882,526, filed on Sep. 25, 2013.

(51) Int. Cl. F01D 25/02; F01D 25/24

(52) U.S. Cl. CPC F01D 25/02; F01D 25/24; F05D 2220/323; F05D 2300/603; F05D 2300/43

(57) ABSTRACT

A jet engine fan case is disclosed. The fan case may comprise an ice liner section and a rear liner section, wherein the ice liner section and the rear liner section are constructed from a constructed from a single, integral material. The ice liner section may comprise fiberglass and the rear liner section comprises fiberglass, such that the combined liner comprises a single piece. The combined liner may comprise a plurality of segments in the range of one segment to nine segments. The ice liner section may comprise a first cross-sectional profile and the rear liner section may comprise a second cross-sectional profile. The ice liner section may comprise a first cross-sectional profile and the rear liner section may comprise a second cross-sectional profile that is less than the first cross-sectional profile. The combined liner may comprise an uninterrupted aerodynamic surface.

### CROSS-REFERENCE TO RELATED APPLICATIONS

This application is a continuation of, claims priority to and the benefit of, PCT/US2014/055593 filed on Sep. 15, 2014 and entitled “COMBINED FAN CASE ICE LINER AND REAR LINER,” which claims priority from U.S. Provisional Application No. 61/882,526 filed on Sep. 25, 2013 and entitled “COMBINED FAN CASE ICE LINER AND REAR LINER.” Both of the aforementioned applications are incorporated herein by reference in their entirety.

### FIELD OF INVENTION

The present disclosure relates to gas engine turbines, and more particularly, to a combined fan case ice liner and rear liner.

### BACKGROUND OF THE INVENTION

Gas turbine engines, such as those that power modern commercial and military aircraft, typically include a fan case that encloses a fan or turbofan. Fan cases typically include one or more liners situated concentrically about an axis. These liners protect the fan case against a variety of damage, including damage by ice ingested by the fan.

### SUMMARY OF THE INVENTION

A jet engine fan case is disclosed herein. The fan case may comprise an ice liner section and a rear liner section, wherein the ice liner section and the rear liner section are constructed from a single, integral, material and comprise a single combined liner. The ice liner section may comprise fiberglass and the rear liner section comprises fiberglass, such that the combined liner comprises a single, integral piece. The combined liner may comprise a plurality of segments in the range of one segment to nine segments, though additional segments are also contemplated. The ice liner section may comprise a first cross-sectional profile and the rear liner section may comprise a second cross-sectional profile. The ice liner section may comprise a first cross-sectional profile and the rear liner section may comprise a second cross-sectional profile that is less than the first cross-sectional profile. The combined liner may comprise an uninterrupted or substantially uninterrupted aerodynamic surface. The combined liner may comprise an aerodynamic surface over which air flows smoothly (e.g., laminarly) between the ice liner section and the rear liner section.

A combined jet engine fan case liner is disclosed. The combined jet engine fan case liner may comprise an ice liner section and a rear liner section, wherein the ice liner section and the rear liner section comprise a single material. The ice liner section and the rear liner section may comprise fiberglass. The ice liner section may comprise a first thickness. The rear liner section may comprise a second thickness. In various embodiments, the rear liner section may comprise a second thickness that is less than the first thickness. The ice liner section and the rear liner section may comprise a single, integral piece. The ice liner section and the rear liner section may comprise a plurality of segments. The ice liner section and the rear liner section may together comprise a number of segments in the range of one segment to nine segments, though additional segments are also contemplated. The combined jet engine fan case liner may comprise an uninterrupted aerodynamic surface. The ice liner section and the rear liner section may comprise an uninterrupted or substantially uninterrupted aerodynamic surface.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the drawing figures, wherein like numerals denote like elements.

FIG. 1A illustrates, in accordance with various embodiments, a perspective view of a fan case having a combined ice liner section and a rear liner section;

FIG. 1B illustrates, in accordance with various embodiments, a perspective view of a segmented ice liner section;

FIG. 1C illustrates, in accordance with various embodiments, a perspective view of a segmented rear liner section;

FIG. 2A illustrates, in accordance with various embodiments, a first cross-sectional view of a fan case liner;

FIG. 2B illustrates, in accordance with various embodiments, a second cross-sectional view of a fan case liner; and

FIG. 2C illustrates, in accordance with various embodiments, a third cross-sectional view of a fan case liner.

### DETAILED DESCRIPTION

The detailed description of exemplary embodiments herein makes reference to the accompanying drawings, which show exemplary embodiments by way of illustration and their best mode. While these exemplary embodiments are described in sufficient detail to enable those skilled in the art to practice the inventions, it should be understood that other embodiments may be realized and that logical, chemical and mechanical changes may be made without departing from the spirit and scope of the inventions. Thus, the detailed description herein is presented for purposes of illustration only and not of limitation. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option. Additionally, any reference to without contact (or similar phrases) may also include reduced contact or minimal contact.

As used herein, “aft” refers to the direction associated with the tail (e.g., the back end) of an aircraft, or generally, to the direction of exhaust of the gas turbine. As used herein, “forward” refers to the directed associated with the nose (e.g., the front end) of an aircraft, or generally, to the direction of flight or motion.

As used herein, a “section” comprises any portion of a fan case liner designed for a particular purpose or use, irrespective of the material composition and/or construction of the section. Thus, an ice liner section may serve as a first impact surface, while a rear liner section, although it may be seamless with the ice liner section, may serve as a second (perhaps identical) impact surface.

As used herein, a “segment” comprises any portion of a fan case liner that is independently manufactured. As described in greater detail below, segments, although manufactured independently, may comprise a same material. One or more segments may be fitted together to form a section of a fan case liner. Thus, as described below, a plurality of segments may be joined to form an ice liner section and/or a rear liner section.

As described above, gas turbine engines (such as those that power modern commercial and military aircraft) typically include a fan case that encloses a fan or turbofan. Fan cases typically include one or more liners situated concentrically about an axis. For instance, fan cases conventionally include a separate ice liner and rear liner. The ice liner is conventionally situated forward of the rear liner.

In operation, ice or other debris may be ingested by the engine fan (or turbofan). As this debris is ingested, it may strike the inner surface of the fan case. Debris may strike a forward portion of the fan case with greater force than an aft portion. Thus, a forward portion, often termed the “ice liner” may be manufactured to a first cross-sectional diameter and/or from very impact resistant material (e.g., a composite material comprising KEVLAR (para-aramid fiber) and a resin such as an epoxy). The aft portion of the fan case may be manufactured to a, second, often lesser, cross-sectional diameter and/or from less impact resistant material (e.g., fiberglass). Both liners may, however, protect the fan case against damage caused by incoming debris, including ice that has accreted on one or more fan blades and is dislodged and ingested by the engine during flight.

Conventionally, the ice and rear liners were constructed from a plurality of circumferentially extending segments, each segment comprising a portion of a 360 degree circumference of a liner section. For instance, many conventional ice liners have been constructed from approximately six to eight segments, while many conventional rear liners have been constructed from approximately two to three segments.

As turbofans have grown larger in diameter, the rotational speed of these fans has decreased. Thus, a fan may strike ingested debris with less energy than experienced in an engine having a smaller, faster spinning, turbofan. Accordingly, the ingested debris may strike the ice and rear liners with energy less than that with which debris may strike a particular liner segment situated within an engine having a smaller, faster spinning, turbofan. Further, in practice, it is quite rare that a segment will be dislodged.

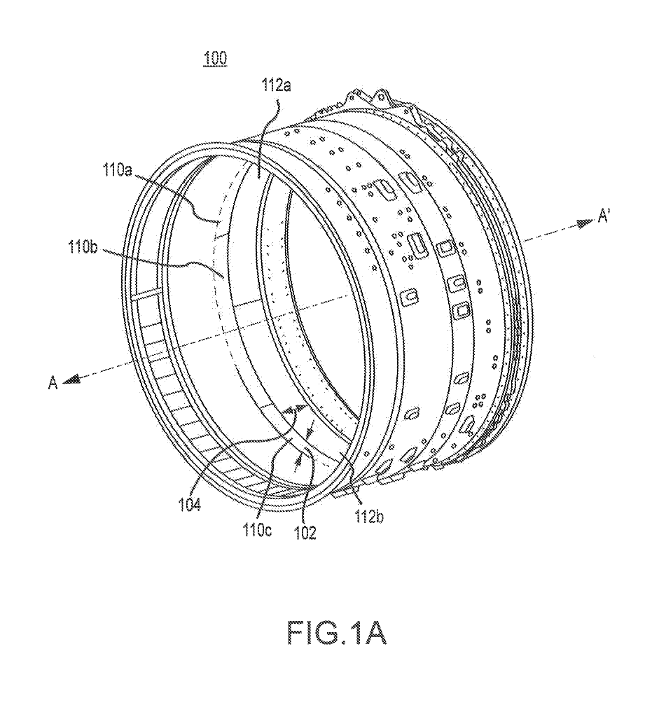

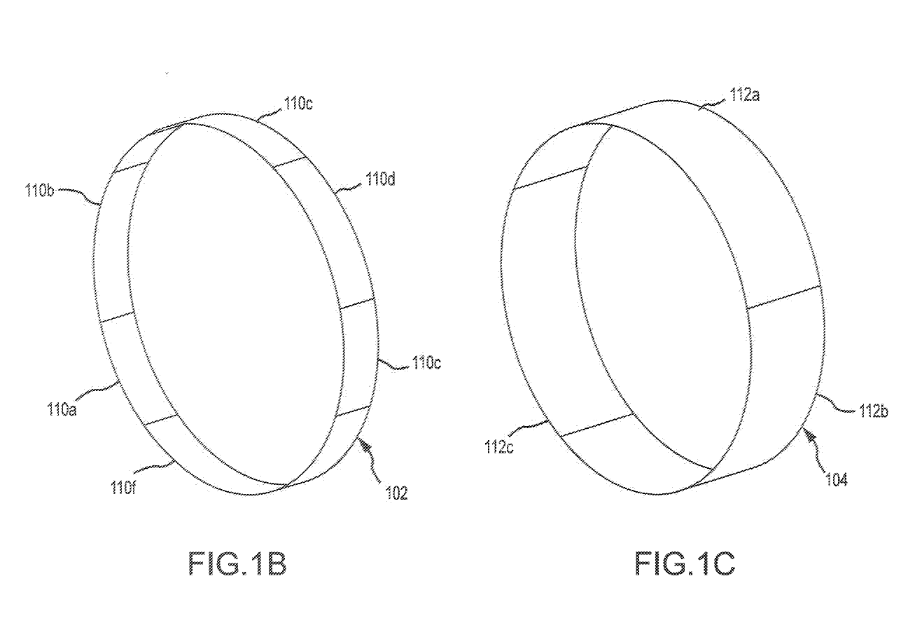

Therefore, in various embodiments, and with reference to FIG. 1A, a fan case 100 is disclosed. The fan case 100 may be concentrically situated along an axis A-A′. The axis A-A′ may extend from forward to aft, such that A marks a forward portion of the fan case 100, while A′ marks an aft portion of the fan case 100.

As shown, the fan case 100 may comprise an ice liner section 102 and/or a rear liner section 104. The ice liner section 102 may be situated forward of the rear liner section 104. In addition, as described in greater detail below, the ice liner section 102 and the rear liner section 104 may be manufactured such that they together form a single or integral product or piece.

As shown in FIGS. 1B and 1C, in various embodiments, an ice liner section 102 and/or a rear liner section 104 may comprise one or more segments that extend circumferentially about the ice liner section 102 and/or the rear liner section 104. For instance, the ice liner section 102 may comprise a plurality of segments, e.g., segments 110a-110e that extend circumferentially to form the ice liner section 102. Thus, as shown, each segment 110a-110e may extend, for example, approximately 60 degrees about the circumference of the ice liner section 102. The rear liner section 104 may likewise comprise a plurality of segments, e.g., segments 112a-112c that extend circumferentially to form the rear liner section 104. Thus, as shown, each segment 112a-112c may extend, for example, approximately 120 degrees about the circumference of the rear liner section 104. However, although the ice liner section 102 is depicted as comprising six segments, this section 102 may comprise any other suitable number of segments. Similarly, although the rear liner section 104 is depicted as comprising three segments, this section 104 may comprise any other suitable number of segments.

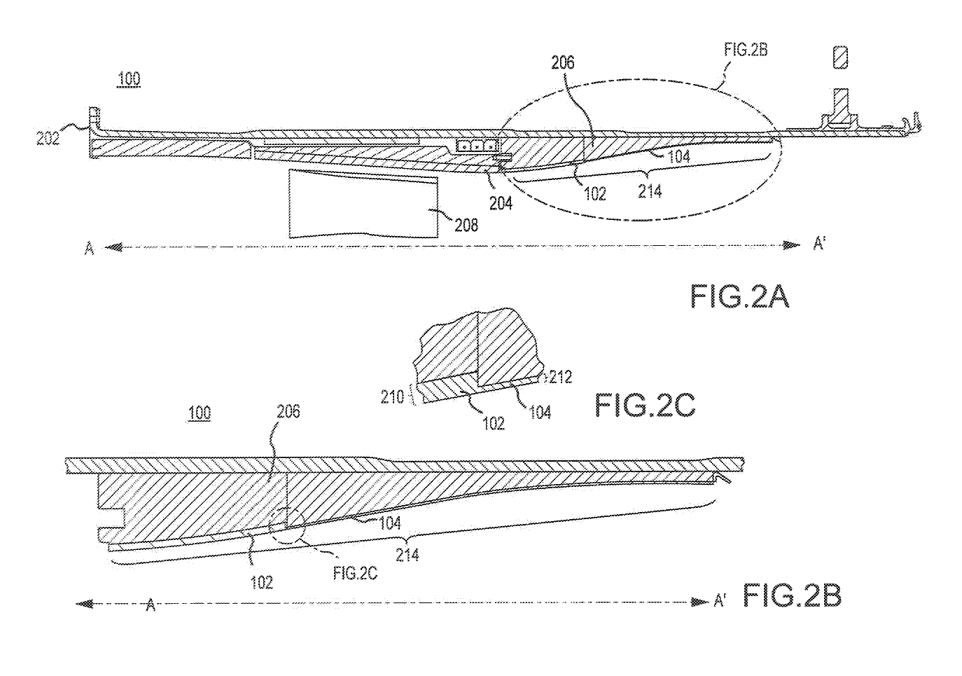

With reference now to FIG. 2A, a cross-sectional view of a fan case 100 is shown. The fan case 100 may comprise a forward flange (or “A-flange”) 202, a rub strip 204, an ice liner section 102, and/or a rear liner section 104. The fan case 100 may further comprise an acoustic structure 206, which may comprise a plurality of honeycomb cells capable of dampening and/or cancelling sound within the fan case 100.

The A-flange 202 may couple the fan case 100 to an air inlet, which may be disposed forward of the fan case 100 and which may receive airflow entering a forward portion of the engine. The rub strip 204 may be situated concentrically about the turbofan, a fan blade 208 of which is depicted in FIG. 2A. The rub strip 204 may interface with the fan blade 208 during operation of the turbofan. For instance, the rub strip 204 may abrade or shave away during operation, because the fan blade 208 may waver slightly as an aircraft makes maneuvers (e.g., landing maneuvers). Thus, the rub strip 204 may prevent contact between the fan case 100 and the fan blade 208, yet maintain a small clearance between itself and the fan blade 208 (thereby reducing wasted airflow).

The ice liner section 102 may, in various embodiments, comprise a first material, such as, for example, fiberglass. The ice liner section 102 may not, in certain embodiments, comprise a heavier duty material, such as a composite material comprising KEVLAR (para-aramid fiber) and a resin such as an epoxy. The rear liner section 104 may comprise a second material, which may be the same as or different from the first material. For example, the rear liner section 104 may comprise fiberglass. In addition, the rear liner section 104 may comprise a heavier or lighter duty material (e.g., structurally more or less impact resistant) than the ice liner section 102. However, in various embodiments, the ice liner section 102 and the rear liner section 104 comprise the same material—fiberglass.

With brief attention to FIG. 2C, the ice liner section 102 may, in various embodiments, comprise a first cross-sectional profile 210. The rear liner section 104 may, in various embodiments, comprise a second cross-sectional profile 212. A cross-sectional profile of a liner may be defined as the surface that would be exposed by making a cut through the liner at a right angle to the axis A-A′.

The thickness of the first cross-sectional profile 210 may be greater than the thickness of the second cross-sectional profile 212. In particular, the ice liner section 102 may comprise a cross-sectional profile 210 to protect against fast moving debris impacting at a forward portion of the fan case 100, while the rear liner section 104 may comprise a cross-sectional profile 212 that is less than the cross-sectional profile 210 to protect against slower moving debris impacting at an aft portion of the fan case 100.

The ice liner section 102 and the rear liner section 104 may, however, comprise the same material, such as fiberglass. In this manner, the ice liner section 102 and the rear liner section 104 may comprise (or be combined as part of) a single, integral, material. This material may be fiberglass, which is typically less expensive than other, more impact resistant materials, such as a composite material comprising KEVLAR (para-aramid fiber) and a resin such as an epoxy. Thus, the total manufacturing cost associated with the fan case 100 may be reduced over that associated with a fan case comprising various materials.

In addition, as described above, the ice liner section 102 and the rear liner section 104 may be manufactured as a single or combined liner 214 (having no radial or circumferential separation between them). Specifically, the ice liner section 102 and the rear liner section 104 may be manufactured as a single, integral, combined liner 214, because they may comprise a single, e.g., woven, material (fiberglass).

Any of the segments described herein (e.g., segments 110a-110e and/or segments 112a-122c) may comprise a single material, and/or one or more of these segments may comprise a variety of materials. In various embodiments, each segment 110a-110e and/or segment 112a-122c comprises fiberglass. The combined liner 214 may, in addition, comprise a single aerodynamic surface or “loft line.” This loft line may not comprise a step or edge between the ice liner section 102 and the rear liner section 104. Rather, the airflow surface may be aerodynamically uninterrupted or substantially uninterrupted by an edge between the ice liner section 102 and the rear liner section 104. Further, the airflow surface of the combined liner 214 may be aerodynamically uninterrupted by edges between segments 110a-110e and/or segments 112a-122c. Thus, the airflow may be laminar or substantially laminar over the combined liner 214. Further still, the loft line may be coated with an aerodynamically suitable substance to improve airflow over the loft line.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the inventions. The scope of the inventions is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching is used throughout the figures to denote different parts but not necessarily to denote the same or different materials.

Systems, methods and apparatus are provided herein. In the detailed description herein, references to “one embodiment”, “an embodiment”, “various embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A fan case comprising:
an ice liner section; and
a rear liner section, wherein the ice liner section and the rear liner section are constructed from a single, integral material.

2. The fan case of claim 2, wherein the ice liner section comprises fiberglass and the rear liner section comprises fiberglass.

3. The fan case of claim 2, wherein the ice liner section and the rear liner section together form a combined liner, wherein the combined liner is continuous from forward to aft, and wherein the combined liner comprises a single piece.

4. The fan case of claim 2, wherein the combined liner comprises a plurality of concentrically situated segments.

5. The fan case of claim 2, wherein the combined liner comprises a number of segments in the range of one segment to nine segments.

6. The fan case of claim 2, wherein the ice liner section comprises a first cross-sectional profile and the rear liner section comprises a second cross-sectional profile.

7. The fan case of claim 2, wherein the ice liner section comprises a first cross-sectional profile and the rear liner section comprises a second cross-sectional profile that is less in thickness than the first cross-sectional profile.

8. The fan case of claim 2, wherein the combined liner comprises an uninterrupted aerodynamic surface.

9. The fan case of claim 2, wherein the combined liner comprises an aerodynamic surface over which air flows laminarly between the ice liner section and the rear liner section.

10. A combined jet engine fan case liner comprising:
an ice liner section; and
a rear liner section, wherein the ice liner section and the rear liner section comprise a single material.

11. The combined jet engine fan case liner of claim 10, wherein the ice liner section and the rear liner section comprise fiberglass.

12. The combined jet engine fan case liner of claim 10, wherein the ice liner section comprises a first thickness and the rear liner section comprises a second thickness.

13. The combined jet engine fan case liner of claim 10, wherein the ice liner section comprises a first thickness and the rear liner section comprises a second thickness that is less than the first thickness.

14. The combined jet engine fan case liner of claim 10, wherein the ice liner section and the rear liner section comprise a single piece.

15. The combined jet engine fan case liner of claim 10, wherein the ice liner section and the rear liner section comprise a plurality of segments.

16. The combined jet engine fan case liner of claim 10, wherein the ice liner section and the rear liner section together comprise a number of segments in the range of one segment to nine segments.

17. The combined jet engine fan case liner of claim 10, wherein the combined jet engine fan case liner comprises an uninterrupted aerodynamic surface.

18. The combined jet engine fan case liner of claim 10, wherein the ice liner section and the rear liner section comprise an uninterrupted aerodynamic surface.
